(19) United States
(12) Patent Application Publication
(10) Pub. No.: US 2026/0254874 A1
(43) Pub. Date: Aug. 27, 2026

(54) Establishing Peering Connections Between Resources Located In Different Cloud Environments

(71) Applicant: Oracle International Corporation, Redwood Shores, CA (US)

(72) Inventors: Peter John Hill, Seattle, WA (US); Myron Decker King, Arlington, MA (US); Eugen Enache, Bucharest (RO); Kirils Zaicenko, Cumming, GA (US)

(73) Assignee: Oracle International Corporation, Redwood Shores, CA (US)

(21) Appl. No.: 19/061,156

(22) Filed: Feb. 24, 2025

(51) Int. Cl. H04L 67/141; G06F 9/54; H04L 9/40

(52) U.S. Cl. CPC H04L 67/141; G06F 9/546; G06F 9/547; H04L 63/126; H04L 2212/00

(57) ABSTRACT

A system executes a process for establishing a peering connection between (a) a first customer resource located in a first customer tenancy of a first cloud environment and (b) a second customer resource located in a second customer tenancy of a second cloud environment. The process includes transmitting a first peering request from the first customer tenancy to the second customer tenancy. The first peering request includes a service key that uniquely identifies the first customer resource. The process includes receiving, from the second customer tenancy, a second peering request that includes the service key transmitted in the first peering request. The process includes, responsive to verifying that the service key of the second peering request uniquely identifies the first customer resource, transmitting a control dataset to the second customer tenancy for configuring the peering connection.

### TECHNICAL FIELD

The present disclosure relates to establishing peering connections between resources of a customer located in different cloud environments. More particularly, the present disclosure relates to establishing peering connections between resources of a customer's tenancies located in different cloud environments provided by different cloud service providers.

### BACKGROUND

Cloud environments of different cloud service providers can allow a customer that utilizes both cloud environments to connect the customer's resources that are located in different customer tenancies of the different cloud environments via virtual route forwarding (VRF)-based network segmentation. VRF-based network segmentation allow different customers to share the same physical network while having their traffic securely isolated. With VRF-based network segmentation, traffic for particular customer networks are assigned their own VRF table, ensuring proper routing and segregation. A particular VRF table includes its own set of routes that prevent traffic of one customer from interacting with or being routed to a different customer.

VRF-based network segmentation has scalability and management limitations. A VRF instance requires memory and processing resources on a router. As the number of VRF instances increases, routers need more processing and storage capacity to handle the load. There is a limit on the number of VRF instances that a router can support, and VRFs utilize specialized hardware that can be expensive. Some customer networks have relatively few connections that may not justify the cost of a VRF system.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and refer to at least one embodiment. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates features of an example system for executing operations pertaining to establishing peering connections between resources of tenancies located in different cloud environments in accordance with one or more embodiments;

FIG. 7 illustrates features of an example system for executing operations pertaining to establishing peering connections between resources of tenancies located in different distributed cloud environments in accordance with one or more embodiments;

FIG. 8 is a flowchart that depicts example operations of an initiating-tenancy entity pertaining to establishing a peering connection between an initiating-tenancy resource located in an initiating tenancy of an initiating cloud environment and a target-tenancy resource located in a target tenancy of a target cloud environment in accordance with one or more embodiments; and

FIG. 9 is a flowchart that depicts example operations of a target-tenancy entity pertaining to establishing a peering connection between an initiating-tenancy resource located in an initiating tenancy of an initiating cloud environment and a target-tenancy resource located in a target tenancy of a target cloud environment in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. SYSTEM ARCHITECTURE FOR EXECUTING OPERATIONS PERTAINING TO ESTABLISHING PEERING CONNECTIONS BETWEEN RESOURCES LOCATED IN DIFFERENT CLOUD ENVIRONMENTS
5. OPERATIONS PERTAINING TO ESTABLISHING PEERING CONNECTIONS BETWEEN RESOURCES LOCATED IN DIFFERENT CLOUD ENVIRONMENTS
6. EXAMPLE MACHINE LEARNING SYSTEM
7. MISCELLANEOUS; EXTENSIONS

### 1. GENERAL OVERVIEW

One or more embodiments use a secure verification process to establish a peering connection between an initiating-tenancy resource located in an initiating tenancy and a target-tenancy resource located in a target tenancy. The peering connection is established based on successfully verifying that a service key transmitted from the target tenancy to the initiating tenancy matches a service key that uniquely identifies the initiating-tenancy resource. In one example, a system includes an initiating-tenancy service that transmits, from the initiating tenancy to the target tenancy, a first peering request that includes a service key that uniquely identifies an initiating-tenancy resource located in the initiating tenancy. Additionally, or alternatively, the system may include a target-tenancy resource located in the target tenancy that, responsive at least in part to receiving the first peering request, transmits a second peering request to the initiating tenancy that includes the service key received from the initiating tenancy in the first peering request. In response to receiving the second peering request, the initiating-tenancy entity verifies that the service key of the second peering request uniquely identifies the initiating-tenancy resource corresponding to the first peering request. Responsive at least in part to verifying that the service key of the second peering request uniquely identifies the initiating-tenancy resource, the system executes one or more operations to establish the peering connection between the initiating-tenancy resource and the target-tenancy resource.

In one example, the initiating tenancy and the target tenancy are associated with a same user or customer. The initiating tenancy and the target tenancy may be located in different cloud environments. The different cloud environments may be operated by different cloud service providers. The initiating-tenancy resource and the target-tenancy resource may be associated with different services or infrastructure provided by the different cloud service providers. The user or customer may restrict access to the initiating tenancy and the target tenancy, for example, such that access to the service key is restricted to one or more authorized entities associated with the user or customer. In one example, because both the initiating tenancy and the target tenancy are associated with a same user or customer and/or because access to the service key is restricted, the system trusts that a peering connection is authorized and proceeds with establishing the peering connection when the service key of the second peering request from the target tenancy uniquely identifies the initiating-tenancy resource of the initiating tenancy.

In one example, after establishing the peering connection, the system transmits messages between the initiating-tenancy resource and the target-tenancy resource. Message senders may encapsulate messages utilizing an encapsulation label from a set of one or more pre-defined encapsulation labels. Message recipients may approve or reject receipt of messages based on verification that the messages are encapsulated using an encapsulation label that corresponds to the set of one or more pre-defined encapsulation labels. Additionally, or alternatively, message senders may attach a source address to message headers from a set of one or more pre-defined source addresses. Message recipients may approve or reject receipt of messages based on verification that the source address attached to the message headers correspond to the set of one or more pre-defined source addresses.

In one example, the peering connection utilizes one-or more pre-existing network routes between the different cloud environments. In one example, the system includes multiple peering connections corresponding to multiple tenancies of different users or customers that concurrently utilize the one-or more pre-existing network routes between the different cloud environments. The system may assign different pre-defined encapsulation labels and/or different source addresses to different tenancies to ensure proper routing and segregation of messages corresponding to the different tenancies.

In one example, multiple instances of an initiating tenancy and/or a target tenancy are located in a distributed cloud environment. The peering connections may utilize existing anycast routes of the cloud service provider that operates the distributed cloud environment. In one example, the system establishes a peering connection with a particular node of the distributed cloud environment and then replicates the peering connection across one or more additional nodes of the distributed cloud environment. Additionally, or alternatively, the system may replicate messages received at a particular node of the distributed cloud environment across one or more additional nodes of the distributed cloud environment.

One or more embodiments described in this Specification and/or recited in the claims may not be included in this General Overview section.

### 2. CLOUD COMPUTING TECHNOLOGY

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on the VMs, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how components interact) can be defined by one or more configuration files. Thus, the overall topology of the infrastructure (e.g., what resources depend on one another and how resources work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

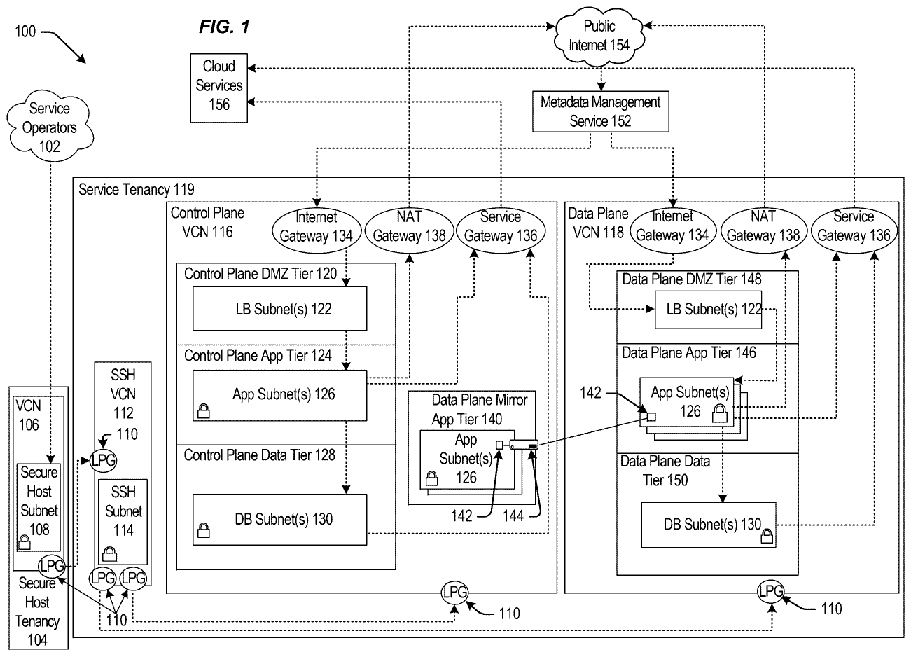

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively coupled to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users,′ or other customers,′ resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

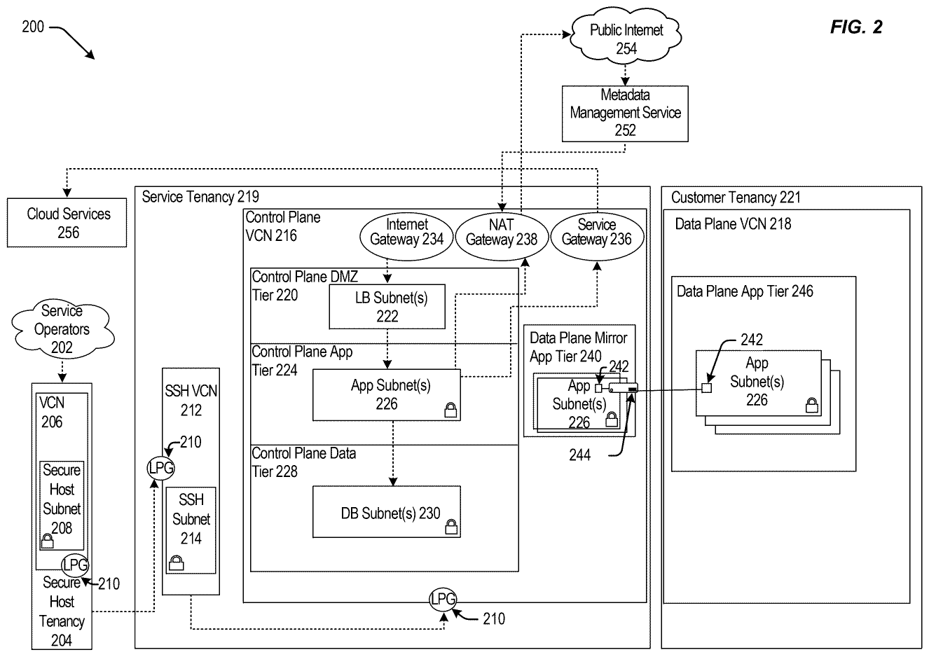

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively coupled to cloud services 256 (e.g., cloud services 156 of FIG. 1).

In some examples, the data plane VCN 218 can be contained in the customer tenancy 221. In this case, the IaaS provider may provide the control plane VCN 216 per customer, and the IaaS provider may, for the customer, set up a unique, compute instance 244 that is contained in the service tenancy 219. Compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

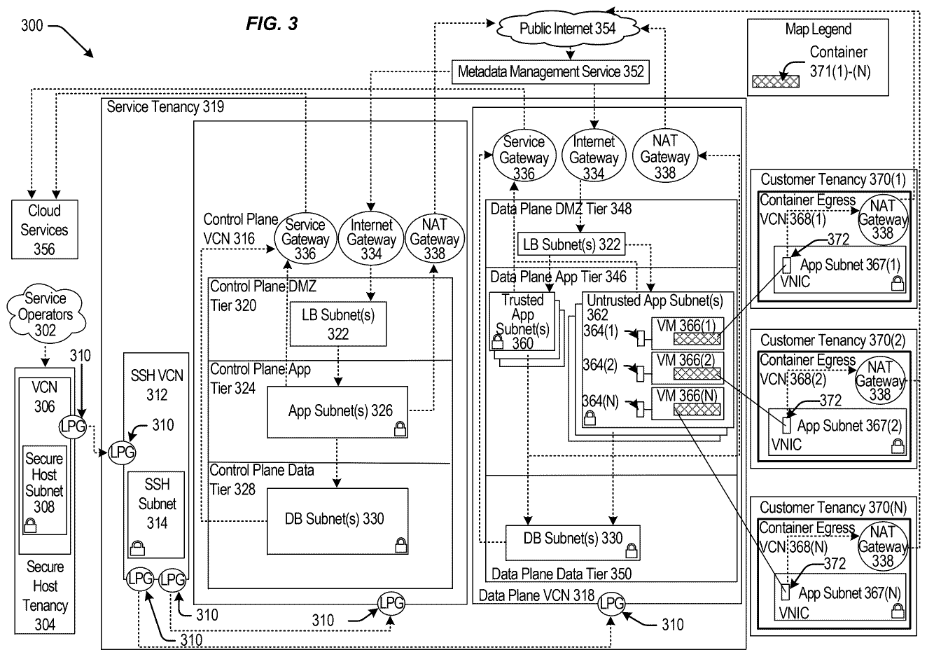

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Tenant(s) VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of the customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

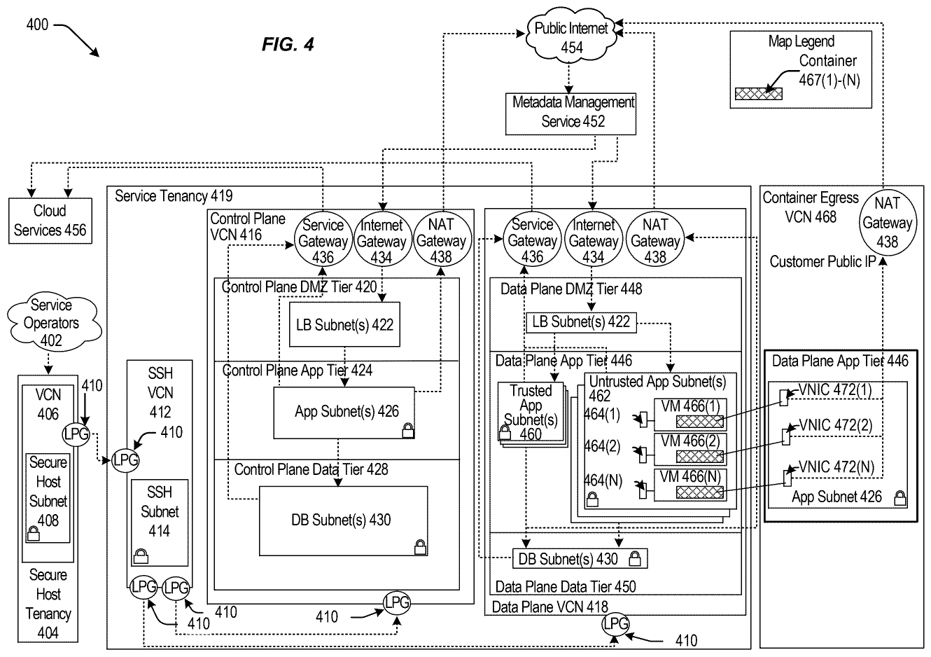

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively coupled to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for customers can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from one other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an API.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of one another. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from one another (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on one other. A call from an application at the private cloud to an application at the public cloud (and vice versa) may be executed through the interface.

In an embodiment, tenants of a multi-tenant computer network are independent of one another. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with other tenants. Various tenant isolation approaches may be used.

In an embodiment, a tenant is associated with a tenant ID. The network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, data structures and/or datasets, stored by the computer network, are tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a particular tenant, a set of applications that the particular tenant is authorized to access. For a particular application, a list of tenant IDs of tenants authorized to access the particular application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. COMPUTER SYSTEM

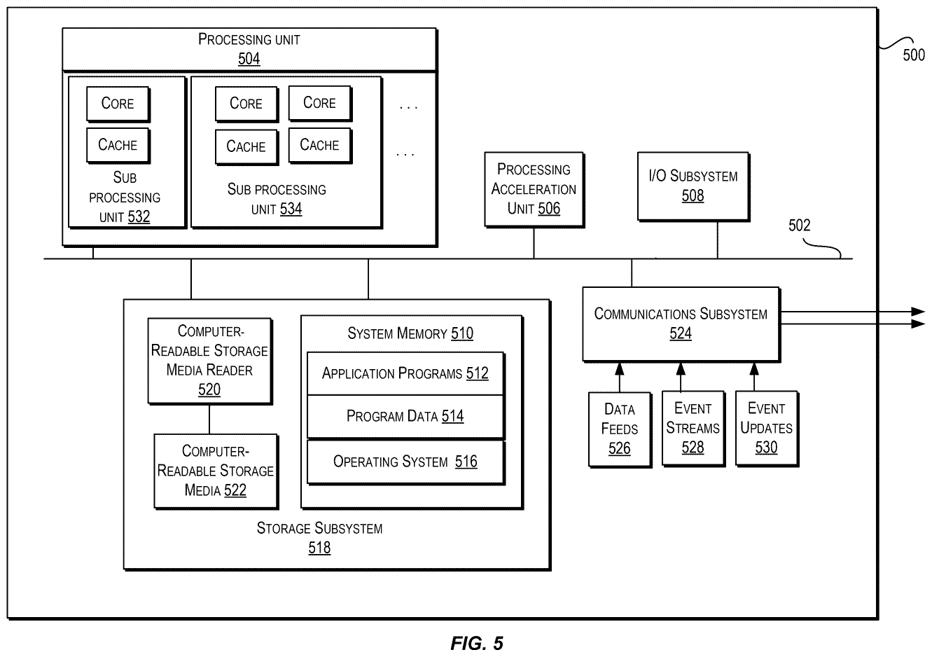

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with one another as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in the processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics, and audio/video information, such as monitors, printers, speakers, headphones, automotive navigation systems, plotters, voice output devices, and modems.

Computer system 500 may comprise a storage subsystem 518 that provides a tangible non-transitory computer-readable media for storing software and data constructs that provide the functionality of the embodiments described in this disclosure. The non-transitory computer-readable media includes instructions that cause performance of operations described herein. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random-access memory (RAM)) and/or non-volatile memory (such as read-only memory (ROM), flash memory, etc.). Different types of RAM configurations may be provided, including a static random-access memory (SRAM), a dynamic random-access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. SYSTEM ARCHITECTURE FOR EXECUTING OPERATIONS PERTAINING TO ESTABLISHING PEERING CONNECTIONS BETWEEN RESOURCES LOCATED IN DIFFERENT CLOUD ENVIRONMENTS

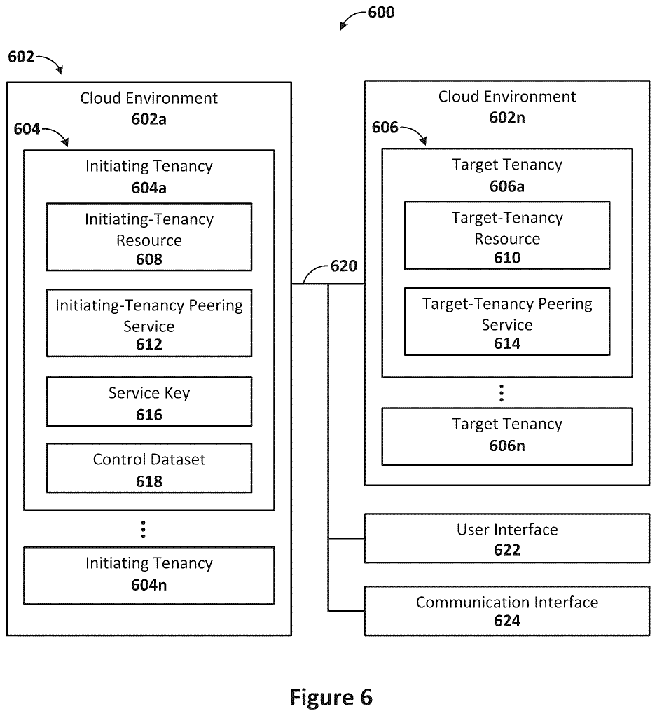

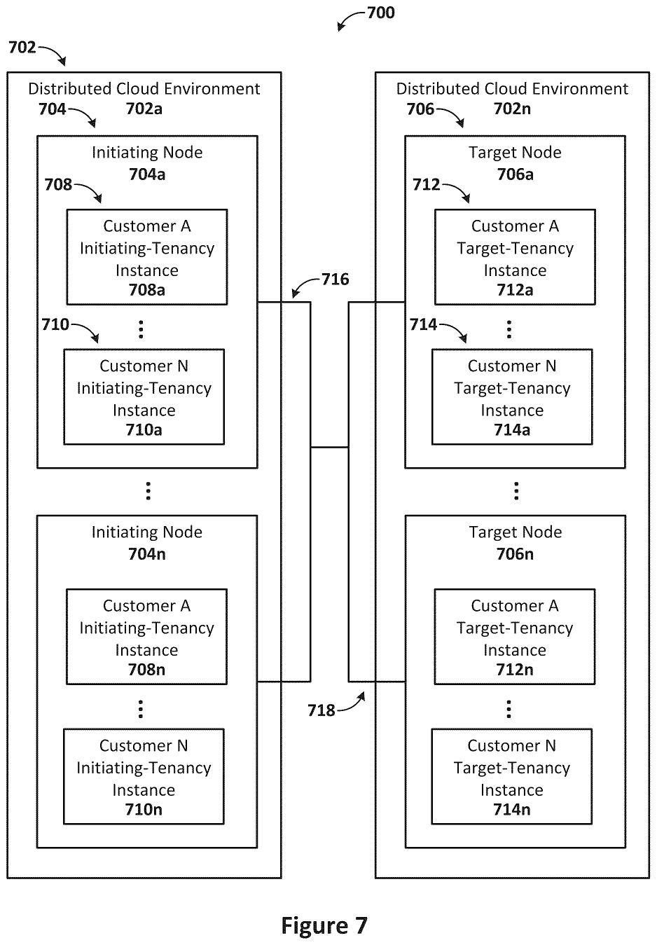

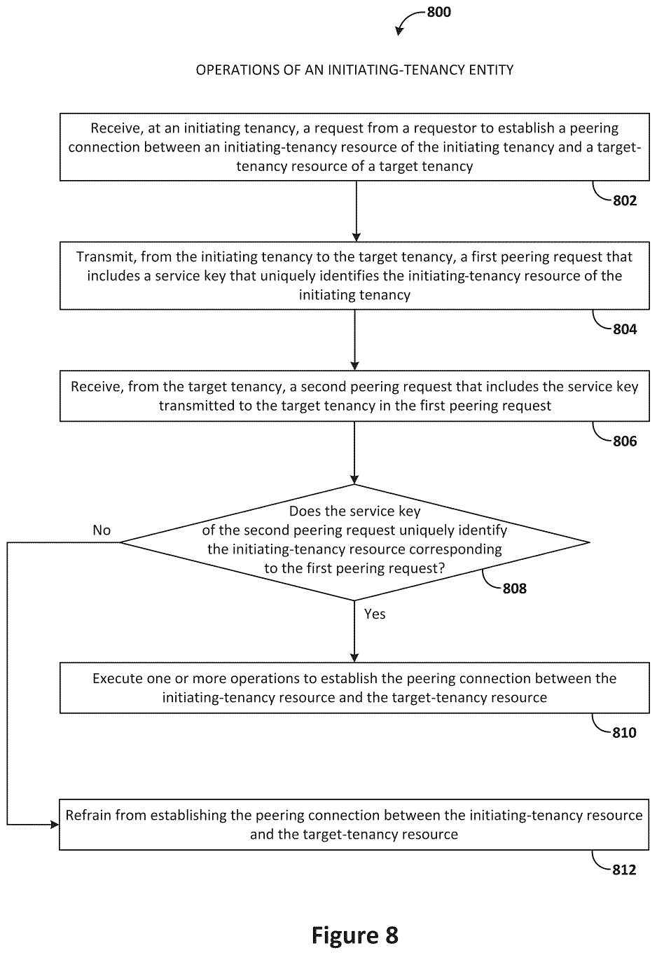

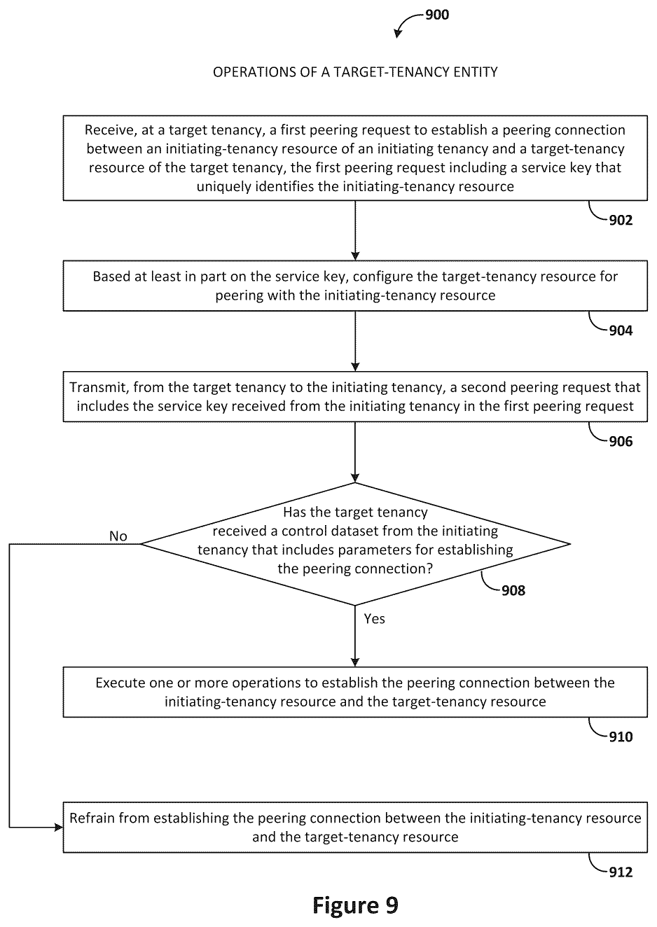

FIGS. 6 and 7 illustrate features of example systems for executing operations pertaining to establishing peering connections between resources located in different cloud environments. In one or more embodiments, the systems described with reference to FIGS. 6 and 7 refer to hardware and/or software configured to perform operations described herein. Examples of operations are described below with reference to FIGS. 8 and 9. In one example, one or more features described with reference to FIG. 6 may be combined with one or more features described with reference to FIG. 7. Additionally, or alternatively, the systems described with reference to FIGS. 6 and 7 may include one or more features described above in Section 2, titled “Cloud Computing Technology,” and/or in Section 3, titled “Computer System.”

In one or more embodiments, a system may include more or fewer components than the components described with reference to FIGS. 6 and 7. The components described with reference to FIGS. 6 and 7 may be local to or remote from each other. The components described with reference to FIGS. 6 and 7 may be implemented in software and/or hardware. The components of FIGS. 6 and 7 may be distributed over multiple applications and/or machines. Multiple components may be combined into one application and/or machine. Operations described with respect to one component may instead be performed by another component.

### A. Example Cloud Environments

As shown in FIG. 6, a system 600 for executing operations pertaining to includes multiple computing environments 602, such as cloud environment 602a and cloud environment 602n. As shown with respect to cloud environment 602a, a cloud environment 602 includes one or more initiating tenancies 604, such as initiating tenancy 604a and initiating tenancy 604n. As shown with respect to cloud environment 602n, a cloud environment 602 includes one or more target tenancies 606, such as target tenancy 606a and target tenancy 606n. As used herein, the term “initiating tenancy” refers to a tenancy of a cloud environment that includes an initiating-tenancy resource. As used herein, the term “initiating-tenancy resource” refers to a resource that is uniquely identified by a service key in a peering request associated with the resource. As used herein, the term “target tenancy” refers to a tenancy of a cloud environment that includes a target-tenancy resource. As used herein, the term “target-tenancy resource” refers to a resource that is identified in a peering request to peer the resource with an initiating-tenancy resource. In one example, a cloud environment 602 may include one or more initiating tenancies and one or more target tenancies. Additionally, or alternatively, a tenancy of a cloud environment 602 may be an initiating tenancy with respect to one or more peering connections and/or a target tenancy with respect to one or more peering connections.

As shown with reference to initiating tenancy 604a, an initiating tenancy 604 includes at least one initiating-tenancy resource 608. As shown with reference to target tenancy 606a, a target tenancy 606 includes and at least one target-tenancy resource 610. As used herein, the term “resource” refers to a computing entity located in a cloud environment that is utilized by at least one tenant. As example, a tenant may utilize a resource to deploy, run, and/or manage workloads, store and/or process data, facilitate networking, and/or leverage managed services within a cloud environment 602. A resource may provide compute, storage, connectivity, and/or platform capabilities to support applications and operations, for example, without requiring direct management of underlying infrastructure. A resource can be provisioned and/or configured by a tenant and/or by a service provider. A resource can be virtualized or abstracted. A resource may be managed by a tenant and/or a cloud provider. A resource may include one or more of the following: a compute instance, a storage volume, a networking component, a managed service, an application, an operating system, a cloud management platform, a security platform, a development tool, a virtual machine, a container, a serverless computing platform, an auto-scaling application, a storage platform, a database instance, a security component, a monitoring component, a development component, a support component, a machine-learning component, an artificial intelligence component, an analytics component, an integration component, a service, or a service feature. Additionally, or alternatively, a resource may include one or more cloud-provided functionalities that support workloads and/or applications executed by a tenant. A resource may include an initiating-tenancy resource 608 and/or a target-tenancy resource 610. In one example, a resource collectively includes an initiating-tenancy resource 608 and a target-tenancy resource 610. Additionally, or alternatively, a resource may include an initiating-tenancy resource 608 that utilizes a target-tenancy resource 610 and/or information from the target-tenancy resource 610 to execute one or more operations. Additionally, or alternatively, a resource may include a target-tenancy resource 610 that utilizes an initiating-tenancy resource 608 and/or information from the initiating-tenancy resource 608 to execute one or more operations.

As shown with reference to initiating tenancy 604a, an initiating tenancy 604 includes an initiating-tenancy peering service 612. The initiating-tenancy peering service 612 executes operations associated with the initiating tenancy 604 pertaining to establishing one or more peering connections between an initiating-tenancy resource 608 and one or more target-tenancy resources 610 located in one or more target tenancies 606. Example operations of the initiating-tenancy peering service 612 are further described below with reference to FIG. 8.

As shown with reference to target tenancy 606a, a target tenancy 606 includes a target-tenancy peering service 614. The target-tenancy peering service 614 executes operations associated with the target tenancy 606 pertaining to establishing one or more peering connections between a target-tenancy resource 610 and one or more initiating-tenancy resources 608 located in one or more initiating tenancies 604. Example operations of the target-tenancy peering service 614 are further described below with reference to FIG. 9.

As further shown with reference to initiating tenancy 604a, an initiating tenancy 604 includes a service key 616 corresponding to an initiating-tenancy resource 608. The service key 616 uniquely identifies the initiating-tenancy resource 608. Different initiating-tenancy resources 608 are uniquely identified by a different service key 616. The initiating-tenancy peering service 612 and the target-tenancy peering service 614 utilize service keys 616 to identify initiating-tenancy resources 608 that are the subject of peering requests for peering with one or more target-tenancy resources 610. A service key 616 is a unique identifier that include metadata about a resource within a cloud environment 602. The metadata of a service key 616 uniquely identifies the resource. In one example, a service key 616 uniquely identifies an initiating-tenancy resource 608. In one example, a service key 616 is a string. The string of a service key 616 may include the metadata that uniquely identifies the resource. The metadata of a service key 616 may include one or more of the following: a resource type, a resource location, a specified use for the resource, or an ID number.

As further shown with reference to initiating tenancy 604a, an initiating tenancy 604 includes a control dataset 618. The control dataset 618 includes data for establishing, maintaining, and/or managing a peering connection. The control dataset 618 may include configuration parameters, routing policy parameters, authentication credentials, and/or negotiation protocols. The configuration parameters may include internet protocols, routing protocols, encapsulation protocols, and addresses utilized for peering. The routing policy parameters may define the rules and conditions under which routes are exchanged, filtered, modified, or prioritized between peering entities. The authentication credentials may include passwords, security keys, certificates, or tokens. The negotiation protocols may include mechanisms for establishing terms of communication via peering connections. In one example, the control dataset 618 identifies a set of one or more encapsulation labels for encapsulating messages transmitted via a peering connection between an initiating-tenancy resource 608 and a target-tenancy resource 610. Additionally, or alternatively, the control dataset 618 may include one or more rules for accepting or rejecting messages based on the set of one or more encapsulation labels. In one example, the control dataset 618 identifies a set of one or more source addresses for transmitting messages via a peering connection between an initiating-tenancy resource 608 and a target-tenancy resource 610. Additionally, or alternatively, the control dataset 618 may include one or more rules for accepting or rejecting messages based on the set of one or more source addresses.

The system 600 may utilize an existing network route 620 for transmitting messages via peering connections between an initiating tenancy 604 and a target tenancy 606. Multiple peering connections between different sets of an initiating tenancy 604 and a target tenancy 606 may utilize the network route 620.

### B. Example Distributed Cloud Environments

As shown in FIG. 7, a system 700 includes multiple distributed cloud environments 702, such as distributed cloud environments 702a and distributed cloud environments 702n. The term “distributed cloud environment” refers to a cloud environment that includes multiple instances of a cloud infrastructure deployed across multiple nodes, for example, at geographically dispersed locations. Multiple instances of a tenancy may be deployed across the multiple nodes, respectively.

As shown with respect to distributed cloud environments 702a, a distributed cloud environment 702 may include multiple initiating nodes 704, such as initiating node 704a and initiating node 704n. As used herein, the term “initiating node” refers to a node of a distributed cloud environment that includes an instance of at least one initiating tenancy. An initiating-tenancy instance may include one or more features of an initiating tenancy described with reference to FIG. 6. Additionally, or alternatively, an initiating-tenancy instance may perform one or more operations described with reference to FIG. 8. In one example, an initiating-tenancy instance includes an initiating-tenancy peering service that performs one or more operations described with reference to FIG. 8. In one example, an initiating tenancy 708 associated with “customer A” includes an initiating-tenancy instance 708a located at initiating node 704a and an initiating-tenancy instance 708n located at initiating node 704n. Additionally, or alternatively, a second initiating tenancy 710, associated with “customer N,” may include an initiating-tenancy instance 710a located at initiating node 704a and an initiating-tenancy instance 710n located at initiating node 704n.

As shown with respect to distributed cloud environments 702n, a distributed cloud environment 702 may include multiple target nodes 706, such as target node 706a and target node 706n. As used herein, the term “target node” refers to a node of a distributed cloud environment that includes an instance of at least one target tenancy. A target-tenancy instance may include one or more features of a target tenancy described with reference to FIG. 6. Additionally, or alternatively, a target-tenancy instance may perform one or more operations described with reference to FIG. 9. In one example, a target-tenancy instance includes a target-tenancy peering service that performs one or more operations described with reference to FIG. 9. In one example, a target tenancy 712 associated with “customer A” includes a target-tenancy instance 712a located at target node 706a and a target-tenancy instance 712n located at target node 706n. Additionally, or alternatively, a second target tenancy 714, associated with “customer N,” may include a target-tenancy instance 714a located at target node 706a and a target-tenancy instance 714n located at target node 706n.

The system 700 may establish a peering connection between multiple initiating-tenancy instances of an initiating tenancy and at least one instance of a target tenancy such as multiple target-tenancy instances of the target tenancy. Additionally, or alternatively, the system 700 may establish a peering connection between multiple target-tenancy instances of a target tenancy and at least one instance of an initiating tenancy such as multiple initiating-tenancy instances of the target tenancy. In one example, the system 700 establishes a peering connection between the multiple initiating-tenancy instances of the initiating tenancy 708, associated with “customer A,” and the multiple target-tenancy instances of the target tenancy 712, associated with “customer A.” Additionally, or alternatively, the system 700 may establish a peering connection between the multiple initiating-tenancy instances of the initiating tenancy 710, associated with “customer N,” and the multiple target-tenancy instances of the target tenancy 714, associated with “customer N.”

One or more peering connections may utilize a set of initiating-node network routes 716 associated with the set of initiating nodes 704 for transmitting messages via peering connections with initiating tenancy instances. In one example, the set of initiating-node network routes 716 are anycast routes. Additionally, or alternatively, one or more peering connections may utilize a set of target-node network routes 718 associated with the set of target nodes 706 for transmitting messages via peering connections with target tenancy instances. In one example, the set of target-node network routes 718 are anycast routes. The anycast routes associated with the initiating nodes 704 and/or the target nodes 706 may direct messages to the nearest or best-performing node. The system 700 may select an initiating node 704 and/or a target node 706 based on one or more performance parameters, such as proximity, latency, or bandwidth. Additionally, or alternatively, the system 700 may select nodes for routing messages based on a routing policy.

### C. Example Interfaces

Referring again to FIG. 6, the system 600 may include a user device interface 622 communicatively coupled or couplable with one or more other components of the system 600. A user device interface 622 may include hardware and/or software configured to facilitate interactions between a user and various aspects of the system 600. The user device interface 622 may render user interface elements and receive input via user interface elements. For example, the user device interface 622 may display outputs generated by the system 600. Additionally, or alternatively, the user device interface 622 may be configured to provide inputs to the system 600. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 622.

In an embodiment, different components of a user device interface 622 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 622 may be specified in one or more other languages, such as Java, C, or C++.

Additionally, or alternatively, the system 600 may include one or more communications interfaces 624 communicatively coupled or couplable with one or more components of the system 600. The one or more communications interfaces 624 may include hardware and/or software configured to transmit data between respective components of the system 600 and/or to transmit data to and/or from the system 600. For example, a communications interface 624 may transmit and/or receive data between and/or among one or more computing environments 602 and/or components of the one or more computing environments 602.

In one example, the system 600 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

### 5. OPERATIONS PERTAINING TO ESTABLISHING PEERING CONNECTIONS BETWEEN RESOURCES LOCATED IN DIFFERENT CLOUD ENVIRONMENTS

Referring now to FIGS. 8 and 9, example operations pertaining to establishing peering connections between resources located in different cloud environments are further described. One or more operations described with reference to FIGS. 8 and 9 may be modified, rearranged, or omitted. Accordingly, the particular sequence of operations described with reference to FIGS. 8 and 9 should not be construed as limiting the scope of one or more embodiments. In one example, the operations described with reference to FIGS. 8 and 9 may be performed by one or more features of the systems described with reference to FIGS. 6 and 7.

### A. Operations Of An Initiating-Tenancy Entity Pertaining To Establishing A Peering Connection Between An Initiating-Tenancy Resource And A Target-Tenancy Resource

Referring to FIG. 8, operations 800 of an initiating-tenancy entity are further described. As used herein, the term “initiating-tenancy entity” refers to one or more computing entities associated with an initiating tenancy of a cloud environment. As described with reference to FIG. 8, a system executes operations 800, for example, via the initiating-tenancy entity, pertaining to establishing a peering connection between an initiating-tenancy resource and a target-tenancy resource. The initiating-tenancy entity may be located within an initiating tenancy. A user or customer associated with the initiating tenancy may manage the initiating tenancy, including the initiating-tenancy entity. Additionally, or alternatively, the initiating-tenancy entity may be located outside of the initiating tenancy such as in a service tenancy associated with a cloud service provider. The cloud service provider may manage the initiating-tenancy entity. In one example, the initiating-tenancy entity executes operations in response to requests from a user or customer associated with the initiating tenancy. In one example, the initiating-tenancy entity is an initiating-tenancy peering service.

As shown in FIG. 8, the system receives, at an initiating tenancy, a request from a requestor to establish a peering connection between an initiating-tenancy resource of the initiating tenancy and a target-tenancy resource of a target tenancy (Operation 802). The request may identify the initiating-tenancy resource and/or the target-tenancy resource. Additionally, or alternatively, the system may generate the initiating-tenancy resource in response to the request. The requestor may include a computing entity associated with the initiating tenancy and/or a user that is authorized to submit the request to establish the peering connection. In one example, the request is received at an initiating-tenancy peering service associated with the initiating tenancy. Additionally, or alternatively, the requestor may be the initiating-tenancy peering service. The request may be transmitted from the requestor to a recipient entity, such as the initiating-tenancy peering service, via an API call.

In response to the request from the requestor, the system transmits, from the initiating tenancy to the target tenancy, a first peering request that includes a service key that uniquely identifies the initiating-tenancy resource of the initiating tenancy (Operation 804). The first peering request includes a request to establish a peering connection between the initiating-tenancy resource and a target-tenancy resource. The first peering request identifies the initiating-tenancy resource, for example, based at least on the service key. In one example, the first peering request identifies the target-tenancy resource. Additionally, or alternatively, a target-tenancy peering service or other computing entity of the target tenancy may determine the target-tenancy resource in response to the first peering request. The initiating-tenancy peering service may generate the first peering request and direct the first peering request to a gateway service or other intermediary associated with an initiating-cloud environment that includes the initiating tenancy. The gateway service or intermediary receives the first peering request from the initiating-tenancy peering service and transmits the request to a target-cloud environment that includes the target tenancy. The system may transmit the first peering request to a gateway service or intermediary associated with the target-cloud environment that includes the target tenancy. The initiating-tenancy peering service may access the service key from a configuration file or metadata associated with the initiating-tenancy resource. Additionally, or alternatively, the initiating-tenancy peering service may access the service key via an API call to a cloud infrastructure management service. In one example, access to the service key is restricted to one or more authorized entities associated with the initiating tenancy such as the initiating-tenancy peering service. In one example, the initiating-tenancy peering service conditions the generating of the first peering request and/or generation of the initiating-tenancy resource on successful validation of a credential associated with the requestor.

After transmitting the first peering request to the target tenancy, the system executes operations with respect to the target tenancy as described below with reference to FIG. 9. The system awaits receipt of a second peering request from the target tenancy to proceed with operations 800 pertaining to the initiating tenancy. At a time after transmitting the first peering request to the target tenancy, the system receives the second peering request from the target tenancy (Operation 806). The second peering request includes the service key that was transmitted to the target tenancy in the first peering request. The system includes the service key in the second peering request as a source of verification that the second peering request corresponds to the first peering request. Additionally, or alternatively, the system may verify that the second peering request is authorized based on the presence of the service key in the second peering request.

In response to receiving the second peering request, the system determines whether the service key of the second peering request uniquely identifies the initiating-tenancy resource corresponding to the first peering request (Operation 808). The initiating-tenancy peering service may compare the instance of the service key from the second peering request to the instance of the service key stored in the initiating tenancy in association with the initiating-tenancy resource. The initiating-tenancy peering service may determine whether the respective instances of the service key match one another. When the system determines that the service key of the second peering request uniquely identifies the initiating-tenancy resource corresponding to the first peering request, the system executes one or more operations to establish the peering connection between the initiating-tenancy resource and the target-tenancy resource (Operation 810). The system establishes the peering connection based on a control dataset that included parameters for configuring the peering connection. The initiating-tenancy peering service configures an initiating-tenancy portion of the peering connection based on the control dataset. The initiating tenancy transmits the control dataset to the target tenancy so that the target tenancy may configure a target-tenancy portion of the peering connection.

In one example, the system configures the peering connection for multiple instances of the initiating-tenancy resource located in multiple instances of the initiating tenancy. A first instance of the initiating-tenancy peering service may configure the peering connection with respect to a first instance of the initiating-tenancy resource located in a first instance of the initiating tenancy. The first instance of the initiating-tenancy peering service may transmit information for configuring the peering connection to a second instance of the initiating-tenancy peering service located in a second instance of the initiating tenancy. The second instance of the initiating-tenancy peering service may configure the peering connection with respect to a second instance of the initiating-tenancy resource located in the second instance of the initiating tenancy.

When the system determines that the service key of the second peering request does not uniquely identify the initiating-tenancy resource corresponding to the first peering request, the system refrains from establishing the peering connection between the initiating-tenancy resource and the target-tenancy resource (Operation 812). In one example, refraining from establishing the peering connection includes transmitting a message to one or more destinations indicating that the request to establish the peering connection is rejected.

In one example, the system may process peering requests associated with multiple initiating-tenancy resources. When the system determines that the service key of the second peering request does not uniquely identify the initiating-tenancy resource corresponding to the first peering request, the system may identify a different initiating-tenancy resource that is uniquely identified by the service key of the second peering request. When the system matches the service key of the second peering request with an initiating-tenancy resource, the system executes one or more operations to establish a peering connection.

### B. Operations Of A Target-Tenancy Entity Pertaining To Establishing A Peering Connection Between An Initiating-Tenancy Resource And A Target-Tenancy Resource

Referring to FIG. 9, operations 900 of a target-tenancy entity are further described. As used herein, the term “target-tenancy entity” refers to one or more computing entities associated with a target tenancy of a cloud environment. As described with reference to FIG. 9, a system executes operations 900, for example, via the target-tenancy entity, pertaining to establishing a peering connection between an initiating-tenancy resource and a target-tenancy resource. The target-tenancy entity may be located within a target tenancy. The target tenancy, including the target-tenancy entity, may be managed by a user or customer associated with the target tenancy. Additionally, or alternatively, the target-tenancy entity may be located outside of the target tenancy such as in a service tenancy associated with a cloud service provider. The cloud service provider may manage the target-tenancy entity. In one example, the target-tenancy entity executes operations in response to requests from a user or customer associated with the target tenancy. In one example, the target-tenancy entity is a target-tenancy peering service.

As shown in FIG. 9, the system receives, at a target tenancy, a first peering request from the initiating tenancy (Operation 902). The first peering request includes a request to establish a peering connection between an initiating-tenancy resource of the initiating tenancy and a target-tenancy resource of the target tenancy. Additionally, the first peering request includes a service key that uniquely identifies the initiating-tenancy resource. In one example, the system receives the first peering request from the initiating-cloud environment at a gateway service or intermediary associated with a target-cloud environment that includes the target tenancy. The gateway service or intermediary may direct the first peering request to a target-tenancy peering service.

Based at least in part on the service key, the system configures the target-tenancy resource for peering with the initiating-tenancy resource (Operation 904). The target-tenancy peering service may identify and/or generate the target-tenancy resource for peering with the initiating-tenancy resource. Upon identifying and/or generating the target-tenancy resource, the target-tenancy peering service configures the target-tenancy resource for peering with the initiating-tenancy resource based at least in part on the service key. The target-tenancy peering service may configure the target-tenancy resource by generating a mapping of the target-tenancy resource to the service key that uniquely identifies the initiating-tenancy resource. The system may direct messages sent via the peering connection to the target-tenancy resource based on the mapping of the target-tenancy resource to the service key that uniquely identifies the initiating-tenancy resource. Additionally, or alternatively, the system may direct messages from the target-tenancy resource to the initiating-tenancy resource via the peering connection based on the mapping of the target-tenancy resource to the service key that uniquely identifies the initiating-tenancy resource. In one example, the target-tenancy peering service conditions the configuration of the target-tenancy resource for peering with the initiating tenancy resource on successful validation of a credential associated with the first peering request.

After configuring the target-tenancy resource for peering with the initiating-tenancy resource, the system transmits, from the target tenancy to the initiating tenancy, a second peering request that includes the service key received from the initiating tenancy in the first peering request (Operation 906). The system includes the service key in the second peering request as a source of verification that the second peering request corresponds to the first peering request. Additionally, or alternatively, the system may verify that the second peering request is authorized based on the presence of the service key in the second peering request. The second peering request identifies the initiating-tenancy resource, for example, based at least on the service key. In one example, the second peering request identifies the target-tenancy resource, for example, based on a service key that uniquely identifies the target-tenancy resource. The target-tenancy peering service may generate the second peering request and direct the second peering request to a gateway service or other intermediary associated with the target-cloud environment that includes the target tenancy. The gateway service or intermediate receives the second peering request from the target-tenancy peering service and transmits the request to the initiating-cloud environment that includes the initiating tenancy. The system may transmit the second peering request to a gateway service or intermediary associated with the initiating-cloud environment that includes the initiating tenancy.

After transmitting the second peering request to the initiating tenancy, the system awaits receipt of a control dataset from the initiating tenancy that includes parameters for establishing the peering connection. The initiating tenancy transmits the control dataset to the target tenancy in response to verifying that the service key of the second peering request uniquely identifies the initiating-tenancy resource corresponding to the first peering request from the initiating tenancy.

The system determines whether the target tenancy has received the control dataset from the initiating tenancy (Operation 908). The control dataset includes parameters for establishing the peering connection. When the system determines that the target tenancy has received the control dataset, the system executes one or more operations to establish the peering connection between the initiating-tenancy resource and the target-tenancy resource (Operation 910). The system establishes the peering connection based on the control dataset.

In one example, the system configures the peering connection for multiple instances of the target-tenancy resource located in multiple instances of the target tenancy. A first instance of the target-tenancy peering service may configure the peering connection with respect to a first instance of the target-tenancy resource located in a first instance of the target tenancy. The first instance of the target-tenancy peering service may transmit information for configuring the peering connection to a second instance of the target-tenancy peering service located in a second instance of the target tenancy. The second instance of the target-tenancy peering service may configure the peering connection with respect to a second instance of the target-tenancy resource located in the second instance of the target tenancy.

When the system determines that the target tenancy has not received the control dataset, the system refrains from establishing the peering connection between the initiating-tenancy resource and the target-tenancy resource (Operation 912). In one example, refraining from establishing the peering connection includes transmitting a message to one or more destinations that indicates that the request to establish the peering connection is rejected.

The system may utilize different instances of the initiating tenancy and/or different instances of the target tenancy for different portions of establishing the peering connection. In one example, the system transmits the first peering request from a first instance of the initiating tenancy and receives the second peering request at a second instance of the initiating tenancy. Additionally, or alternatively, the system transmits the first peering request to a first instance of the target tenancy and transmits the second peering request to the initiating tenancy from a second instance of the target tenancy.

### C. Transmitting Messages Via A Peering Connection

After establishing the peering connection, the system transmits messages between one or more instances of the initiating tenancy and one or more instances of the target tenancy via the peering connection. The messages include an encapsulation label that encapsulates a payload. The system may select an encapsulation label from a set of pre-defined encapsulation labels assigned for the peering connection, the initiating-tenancy resource, and/or the target-tenancy resource. Additionally, or alternatively, the messages may include a destination address corresponding to the destination tenancy and/or a source address corresponding to the source tenancy. The source address may be an anycast address corresponding to multiple instances of the source tenancy. The destination address may be an anycast address corresponding to multiple instances of the destination tenancy. A message received at a fist instance of a destination tenancy may transmit the message to additional instances of the destination tenancy.

The system may generate messages based on destination addresses and/or encapsulation labels mapped to the initiating-tenancy resource and/or the target-tenancy resource. The system may determine a destination address for a message based on the mapping of the destination address to the initiating-tenancy resource and/or the target-tenancy resource. Upon determining the destination address, the system may add the destination address to a header of the message. The system may determine an encapsulation label for a message based on the mapping of the encapsulation label to the initiating-tenancy resource and/or the target-tenancy resource. Upon determining the encapsulation label, the system may encapsulate a payload of the message with the encapsulation label.

In one example, the initiating-cloud environment and/or the target-cloud environment includes a routing service that maintains a set of mappings of tenancies to encapsulation labels corresponding to a multiple peering connections between tenancies in different cloud environments. The routing service utilizes the set of mappings to determine encapsulation labels for encapsulating payloads of messages for transmission via the multiple peering connections. Additionally, or alternatively, the routing service may maintain a set of mappings of tenancies to destination addresses corresponding to multiple peering connections between tenancies in different cloud environments. The routing service may utilize the set of mappings to determine destination addresses for transmitting messages via the multiple peering connections.

When a tenancy receives a message via a peering connection, the tenancy may execute a security protocol to validate the message based on the source address and/or the encapsulation label of the message. In one example, upon receipt of a message, the system determines a source address of the message. The system may locate the source address from a header of the message. The system accesses a set of one or more pre-defined source addresses. The system may validate the message based at least in part on determining whether the set of pre-defined source addresses includes the source address of the message. The system may determine that the message is valid when the set of pre-defined source addresses includes the source address of the message. The system may condition providing the message to the destination resource at least on successfully verifying that the set of pre-defined source addresses includes the source address of the message. The system may reject the message based at least on determining that the set of pre-defined source addresses is exclusive of the source address of the message.

Additionally, or alternatively, upon receipt of a message, the system determines an encapsulation label of the message. The system may determine the encapsulation label from a header of the message, from a protocol-specific field or identifier, and/or based on a pre-defined encapsulation rule. The system may access a set of one or more pre-defined encapsulation labels. The system may validate the message based at least in part on determining whether the set of pre-defined encapsulation labels includes the encapsulation label of the message. The system may determine that the message is valid when the set of pre-defined encapsulation labels includes the encapsulation label of the message. The system may condition providing the message to the destination resource at least on successfully verifying that the set of pre-defined encapsulation labels includes the encapsulation label of the message. The system may reject the message based at least on determining that the set of pre-defined encapsulation labels is exclusive of the encapsulation label of the message. The destination resource may access the message after successfully validating the message. The system may refrain from directing the message to the destination resource when the system rejects the message, for example, based on the source address and/or the encapsulation label of the message.

### 6. MISCELLANEOUS; EXTENSIONS

Embodiments are directed to a system with one or more devices that include a hardware processor and that are configured to perform any of the operations described herein and/or recited in any of the claims below. Embodiments are directed to a system that includes means to perform any of the operations described herein and/or recited in any of the claims below. In an embodiment, a non-transitory, computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. Accordingly, the specification and drawings are to be regarded in an illustrative rather than a restrictive sense. The sole and exclusive indicator of the scope of patent protection, and what is intended by the applicants to be the scope of patent protection, is the literal and equivalent scope of the set of claims that issue from this application in the specific form that such claims issue, including any subsequent correction.

References, including publications, patent applications, and patents, cited herein are hereby incorporated by reference to the same extent as if the references were individually and specifically indicated to be incorporated by reference and were set forth in entirety herein.

What is claimed is:

1. A method, comprising:
executing, by a first peering service located in a first customer tenancy of a first cloud environment, a first process for establishing a first peering connection between (a) a first customer resource located in the first customer tenancy and (b) a second customer resource located in a second customer tenancy of a second cloud environment;
wherein the first process executed by the first peering service for establishing the first peering connection comprises:
transmitting a first peering request to a second peering service located in the second customer tenancy, the first peering request comprising a service key that uniquely identifies the first customer resource;
receiving, from the second peering service, a second peering request comprising the service key transmitted to the second peering service in the first peering request;
verifying that the service key of the second peering request uniquely identifies the first customer resource of the first peering request;
responsive to successfully verifying the service key, transmitting a control dataset to the second peering service for configuring the first peering connection, wherein the first peering connection is established based at least in part on the control dataset;
wherein the method is performed by at least one device including a hardware processor.

2. The method of claim 1, further comprising:
executing, by the second peering service, a second process for establishing the first peering connection;
wherein the second process executed by the second peering service for establishing the first peering connection comprises:
accessing the service key from the first peering request;
configuring, based at least in part on the service key, the second customer resource for peering with the first customer resource;
transmitting the second peering request to the first peering service;
receiving the control dataset from the first peering service;
configuring the first peering connection based at least in part on the control dataset.

3. The method of claim 2, further comprising:
configuring, via a first instance of the first peering service, the first peering connection for a first instance of the second customer resource located in a first instance of the second customer tenancy;
configuring, via a second instance of the first peering service, the first peering connection for a second instance of the second customer resource located in a second instance of the second customer tenancy, wherein configuring the first peering connection for the second instance of the second customer resource comprises:
receiving the service key and the control dataset from the first instance of the second customer tenancy;
configuring, based at least in part on the service key, the second instance of the second customer resource for peering with the first customer resource;
configuring the first peering connection for the second instance of the second customer resource based at least in part on the control dataset.

4. The method of claim 1, further comprising:
transmitting the first peering request to a first instance of the second peering service located in a first instance of the second customer tenancy,
wherein the first instance of the second peering service configures, based at least in part on the service key, a first instance of the second customer resource for peering with the first customer resource;
receiving the second peering request from a second instance of the second peering service located in a second instance of the second customer tenancy,
wherein the second instance of the second peering service executes a second peering process for establishing the first peering connection, the second peering process comprising:
receiving the service key from the first instance of the second customer tenancy;
configuring, based at least in part on the service key, a second instance of the second customer resource for peering with the first customer resource; and
transmitting the second peering request to the first peering service;
wherein the first instance of the second customer tenancy and the second instance of the second customer tenancy are located in different cloud environments.

5. The method of claim 4, further comprising:
transmitting the first peering request from a first instance of the first peering service located in a first instance of the first customer tenancy;
receiving the second peering request at a second instance of the first peering service located in a second instance of the first customer tenancy;
wherein the first process comprises:
verifying, via the second instance of the first peering service, that the service key of the second peering request uniquely identifies the first customer resource of the first peering request;
responsive to successfully verifying the service key, transmitting the control dataset from the second instance of the first customer tenancy to the second peering service for configuring the first peering connection;
wherein the first instance of the first customer tenancy and the second instance of the first customer tenancy are located in different cloud environments.

6. The method of claim 1, further comprising:
subsequent to establishing the first peering connection:
transmitting, via the first peering connection, a message from the first customer tenancy to the second customer tenancy, wherein the message comprises:
an encapsulation label encapsulating a payload;
a destination address corresponding to the second customer tenancy; and
a source address corresponding to the first customer tenancy.

7. The method of claim 6, wherein the source address comprises an anycast address corresponding to a plurality of instances of the first customer tenancy.

8. The method of claim 6, wherein the destination address comprises an anycast address corresponding to a plurality of instances of the second customer tenancy.

9. The method of claim 8, wherein transmitting the message from the first customer tenancy to the second customer tenancy comprises:
transmitting a first instance of the message, via the anycast address, from the first customer tenancy to a first instance of the second customer tenancy; and
transmitting a second instance of the message from the first instance of the second customer tenancy to a second instance of the second customer tenancy.

10. The method of claim 6, further comprising:
generating the message, wherein generating the message comprises:
determining the destination address based on a mapping of the destination address to at least one of: the first customer resource or the second customer resource.

11. The method of claim 10, wherein the first cloud environment comprises a routing service that maintains a set of mappings of customer resource to destination addresses corresponding to a plurality of peering connections between customer resources in different cloud environments, wherein the routing service utilizes the set of mappings to transmit messages via the plurality of peering connections.

12. The method of claim 6, further comprising:
generating the message, wherein generating the message comprises:
determining the encapsulation label based on a mapping of the encapsulation label to at least one of: the first customer resource or the second customer resource.

13. The method of claim 12, wherein the first cloud environment comprises a routing service that maintains a set of mappings of customer tenancies to encapsulation labels corresponding to a plurality of peering connections between customer tenancies in different cloud environments, wherein the routing service utilizes the set of mappings to determine encapsulation labels for encapsulating payloads of messages for transmission via the plurality of peering connections.

14. The method of claim 6, further comprising:
receiving the message at the second cloud environment via the first peering connection;
executing a security protocol, comprising:
determining, based on the message, the source address of the message;
accessing a set of pre-defined source addresses;
validating the message based at least in part on determining that the set of pre-defined source addresses comprises the source address of the message, wherein the second customer resource accesses the message after validating the message.

15. The method of claim 6, further comprising:
receiving the message at the second cloud environment via the first peering connection;
executing a security protocol, comprising:
determining the encapsulation label of the message;
accessing a set of pre-defined encapsulation labels;
validating the message based at least in part on determining that the set of pre-defined encapsulation labels comprises the encapsulation label of the message, wherein the second customer resource accesses the message after validating the message.

16. The method of claim 6, further comprising:
receiving the message at the second cloud environment via the first peering connection;
executing a security protocol, comprising:
determining, based on the message, the source address of the message;
accessing a set of pre-defined source addresses;
rejecting the message based at least in part on determining that the set of pre-defined source addresses is exclusive of the source address of the message, wherein rejecting the message comprises refraining from directing the message for access by the second customer resource.

17. The method of claim 6, further comprising:
receiving the message at the second cloud environment via the first peering connection;
executing a security protocol, comprising:
determining the encapsulation label of the message;
accessing a set of pre-defined encapsulation labels;
rejecting the message based at least in part on determining that the set of pre-defined encapsulation labels is exclusive of the encapsulation label of the message, wherein rejecting the message comprises refraining from directing the message for access by the second customer resource.

18. The method of claim 1, further comprising:
establishing the first peering connection between a first set of customer resources of a first customer, the first set of customer resources comprising the first customer resource and the second customer resource;
establishing a second peering connection between a second set of customer resources of a second customer, a first portion of the second set of customer resources located in the first cloud environment and a second portion of the second set of customer resources located in the second cloud environment;
subsequent to establishing the first peering connection and the second peering connection:
transmitting a first set of messages between the first set of customer resources via a first a set of anycast routes of a first cloud service provider corresponding to the first cloud environment and a second set of anycast routes of a second cloud service provider corresponding to the second cloud environment;
transmitting a second set of messages between the second set of customer resources via the first a set of anycast routes and the second set of anycast routes.

19. One or more non-transitory computer-readable media comprising instructions that, when executed by one or more hardware processors, cause performance of operations comprising:
executing, by a first peering service located in a first customer tenancy of a first cloud environment, a first process for establishing a first peering connection between (a) a first customer resource located in the first customer tenancy and (b) a second customer resource located in a second customer tenancy of a second cloud environment;
wherein the first process executed by the first peering service for establishing the first peering connection comprises:
transmitting a first peering request to a second peering service located in the second customer tenancy, the first peering request comprising a service key that uniquely identifies the first customer resource;
receiving, from the second peering service, a second peering request comprising the service key transmitted to the second peering service in the first peering request;
verifying that the service key of the second peering request uniquely identifies the first customer resource of the first peering request;
responsive to successfully verifying the service key, transmitting a control dataset to the second peering service for configuring the first peering connection, wherein the first peering connection is established based at least in part on the control dataset.

20. A system comprising:
at least one device including a hardware processor;
the system being configured to perform operations comprising:
executing, by a first peering service located in a first customer tenancy of a first cloud environment, a first process for establishing a first peering connection between (a) a first customer resource located in the first customer tenancy and (b) a second customer resource located in a second customer tenancy of a second cloud environment;
wherein the first process executed by the first peering service for establishing the first peering connection comprises:
transmitting a first peering request to a second peering service located in the second customer tenancy, the first peering request comprising a service key that uniquely identifies the first customer resource;
receiving, from the second peering service, a second peering request comprising the service key transmitted to the second peering service in the first peering request;
verifying that the service key of the second peering request uniquely identifies the first customer resource of the first peering request;
responsive to successfully verifying the service key, transmitting a control dataset to the second peering service for configuring the first peering connection, wherein the first peering connection is established based at least in part on the control dataset.
